(19) United States
(12) Patent Application Publication
(10) Pub. No.: US 2018/0126936 A1
(43) Pub. Date: May 10, 2018

(54) Method for Operating an Inertial Sensor and for Operating a Vehicle Having Such an Inertial Sensor, and Such a Vehicle

(71) Applicant: Robert Bosch GmbH, Stuttgart (DE)

(72) Inventors: David Nell, Loewenstein (DE); Henning Tuexen, Lehrensteinfsfeld (DE)

(21) Appl. No.: 15/574,874

(22) PCT Filed: Mar. 8, 2016
(86) PCT No.: PCT/EP2016/054897

§ 371 Date: Nov. 17, 2017

(30) Foreign Application Priority Data
May 19, 2015 (DE) 10 2015 209 132.5

(51) Int. Cl. B60R 21/0132; B60T 8/175; B60T 8/1763; B60T 8/58; B60T 8/88; G05B 9/03

(52) U.S. Cl. CPC B60R 21/0132; B60T 8/175; G05B 9/03; B60T 8/58; B60T 8/885; B60T 8/17636

(57) ABSTRACT

The disclosure relates to a method for operating an inertial sensor of a vehicle, in particular a motor vehicle, wherein measurement data of at least one measurement variable of the inertial sensor are captured during operation of the vehicle and are checked for error values in order to calibrate the inertial sensor. According to the disclosure, during operation of the vehicle, measurement data of a different measurement variable, which, however, correlates with the measurement variable of the inertial sensor, are captured by means of a reference sensor and are compared with the measurement data of the inertial sensor in order to record the error values in accordance with a deviation of the measurement data of the inertial sensor from the measurement data of the reference sensor.

The invention relates to a method for operating an inertial sensor of a vehicle, particularly of a motor vehicle, wherein measurement data of a measurement variable of the inertial sensor are detected in operation of the vehicle and checked for error values for a calibration.

Furthermore, the invention relates to a method for operating a vehicle, particularly a motor vehicle, which has at least one inertial sensor, wherein, in dependence on measurement data at least one measurement variable of the inertial sensor a function, particularly a safety function/device such as an airbag or a braking system, of the vehicle is triggered.

Furthermore, the invention relates to a vehicle, particularly a motor vehicle, which has at least one inertial sensor and, in particular, one device triggerable in dependence on measurement data of at least one measurement variable of the inertial sensor, particularly a safety device such as an airbag or a braking system, especially ESP.

### PRIOR ART

From the laid-open document DE 101 62 689 A1, it is already known to validate the measurement data of an inertial sensor system by providing the inertial sensor system redundantly.

By this means, measurement errors can be detected and compensated for. For the calibration of the inertial sensors it is in this case known to determine via long-term measurements of the inertial sensor in a reference coordinate system measurement value errors or offset values which can then be taken into consideration for calibrating the inertial sensor. Because an installed position of the inertial sensor which is 100% correct can be scarcely guaranteed, such a calibration of the inertial sensor is necessary but also leads to a corresponding expenditure since often a long period is needed for monitoring the measurement data and a meaningful measurement is only possible in certain situations.

### DISCLOSURE OF THE INVENTION

The method according to the invention, having the features of claim 1, has the advantage that a calibration of the inertial sensor can be carried out with less effort and more precisely than previously. For this purpose, the method according to the invention provides that in operation of the vehicle, by means of a reference sensor, measurement data of another measurement variable which, however, correlates with the measurement variable of the inertial sensor are detected and compared with the measurement data of the inertial sensor in order to detect error values in dependence on a deviation of the measurement data of the inertial sensor from the measurement data of the reference sensor. Thus, it is not measurement data of a redundant system which are used for the comparison of the measurement data of the inertial sensor, but measurement data of a reference system which detects a measurement variable which differs from the measurement variables of the inertial sensor. To this extent, the reference sensor is not an inertial sensor which detects accelerations and/or rates of rotation by means of a measurement of inertia, but a sensor which, in particular, detects a relative movement as the measurement variable. In this context, a relative movement which correlates with the measurement variable of the inertial sensor is chosen as the relative movement, so that a reference variable by means of which the measurement data of the inertial sensor can be validated can be calculated or determined from the determined measurement variable of the reference sensor.

According to a preferred development of the invention it is provided that a rotational speed sensor which detects the rotational speed of a wheel of the vehicle is provided as a reference sensor. Rotational speed sensors are usually provided already in vehicles, particularly motor vehicles, so that this does not mean additional expenditure. It is only the measurement data of the rotational speed sensor which are also evaluated in operation of the motor vehicle. The important factor is naturally that the measurement data of the inertial sensor and of the reference sensor are detected at the same time in order to provide for a meaningful comparison.

From the detected rotational speed, an acceleration of the vehicle is preferably determined or calculated, respectively. This acceleration can then be compared with the acceleration (measurement variable) detected by the inertial sensor. If the calculated acceleration deviates from the acceleration determined by the inertial sensor, the inertial sensor is correspondingly calibrated, for example by taking into consideration, apart from the measurement data detected by it, also the measurement data of the reference sensor, especially in the form of an offset value from the measurement data of the inertial sensor to the measurement data of the reference sensor.

Furthermore, it is preferably provided that the acceleration is calculated alternatively in dependence on a steering angle of the vehicle, so that a steering angle sensor is provided or used as a reference sensor. By this means, it is not only the amount of acceleration but also the direction of the acceleration of the vehicle which is calculated in dependence on the rotational speed of the wheel of the vehicle, so that an optimal comparison of the acceleration detected by the inertial sensor with the calculated acceleration is made.

The method according to the invention for operating a vehicle having the features of claim 5 is characterized by the fact that the inertial sensor is calibrated by the method according to the invention. This results in the aforementioned advantages. Further features and advantages are obtained from that which is described previously and from the claims.

The vehicle according to the invention, having the features of claim 6, is characterized by the fact that a reference sensor for detecting another measurement variable which, however, correlates with the measurement variable of the inertial sensor, as well as a control device, are provided, wherein the control device calibrates the inertial sensor in dependence on a deviation of the measurement data of the inertial sensor from the measurement data of the reference sensor. This results in the aforementioned advantages.

According to an advantageous development of the invention, it is provided that the inertial sensor is permanently installed in the vehicle. The inertial sensor is thus a fixed component of the vehicle, for example the inertial sensor of a safety system of the vehicle.

Alternatively, it is preferably provided that the inertial sensor is a component of a mobile computer arranged in the vehicle, particularly a tablet computer or mobile telephone. By means of a wireless or cable-connected communication link, the mobile computer can be connected for signal transmission to the vehicle in order to acquire the data of the reference sensor so that the mounting position of the mobile computer in the vehicle can be determined by means of the inertial sensor of the mobile computer. For this purpose, the mobile computer is suitably provided with a corresponding program which performs the method according to the invention.

In the text which follows, the invention will be explained in greater detail by means of an exemplary embodiment, in which:

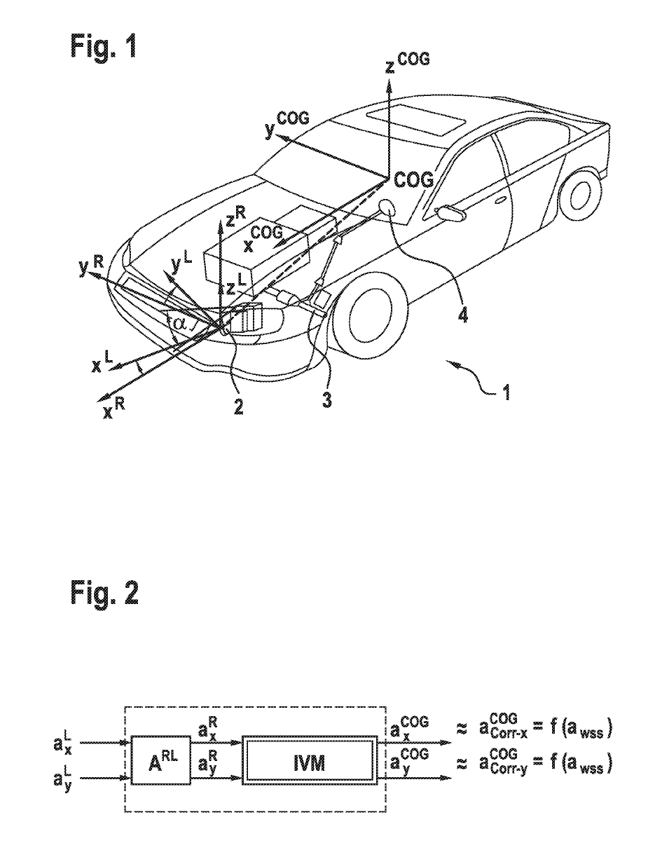

FIG. 1 shows a motor vehicle with an inertial sensor in a simplified representation,

FIG. 2 shows a simplified model of calculation.

FIG. 1 shows in a simplified representation a motor vehicle 1 which has a reference coordinate system (COG) and an inertial sensor 2 which acquires accelerations in three spatial directions x, y, z and to this extent has an inertial sensor coordinate system L which, in dependence on the mounting position of the inertial sensor 2, deviates from a reference coordinate system R aligned in parallel with the motor vehicle coordinate system COG. Furthermore, at least one rotational speed sensor, which forms a reference sensor 3, is allocated to at least one of the wheels of the motor vehicle 1. Preferably, two rotational speed sensors are provided overall. The inertial sensor 2 is, for example, connected directly or by a control device to a safety device 4, for example an airbag device, in order if necessary, to trigger the safety device 4, in dependence on measurement data detected by the inertial sensor.

The inertial sensor 2 acquires at least three measurement variables, namely accelerations in the three spatial directions x, y and z. In order to reliably ensure a triggering of the safety device 4, the actual mounting position of the inertial sensor 2 must be taken into consideration in order to be able to calibrate it so that a coordinate system L corresponds to the reference coordinate system R. For this purpose, the following method is proposed:

In principle, the method is based on a comparison of the measurement data of the measurement variables of the inertial sensor 2, that is to say the accelerations measured in the various spatial directions x, y and z, with correlation data from the reference coordinate system R. For this purpose, measurement data of the measurement variable of the rotational speed sensor are presently detected. The detected rotational speed here does not directly correspond to the acceleration in the x direction detected by the inertial sensor 2 but correlates the rotational speed with the longitudinal acceleration in the x direction of the motor vehicle 1. It is thus possible to calculate from the rotational speed, that is to say from the measurement data of the measurement variable of the reference sensor 3, acceleration values and to compare these with the acceleration values or measurement variables, respectively, of the inertial sensor 2 to determine deviations of measurement data from each other which can then be compensated for or balanced during a calibration of the inertial sensor 2. Initially, it is assumed that the z axis of the inertial sensor 2 corresponds to the vertical vehicle axis. An extension of the method to the three-dimensional space is also conceivable, however. To calculate the mounting angle of the inertial sensor 2, the acceleration values already existing (measurement data of the measurement variables in the x and y direction) are determined from the inertial sensor and the correlation data of the reference sensor 3. In this context, the problem can be abstracted to the model shown in FIG. 2. In this context, the following parameters apply:

a^{L}ₓ=accelerations in the x direction detected by the inertial sensor 2,

a^{L}_{y}=acceleration in the y direction detected by the inertial sensor 2,

a^{RL}=deviation of the detected values of the inertial sensor 2 from the reference coordinates,

a^{R}ₓ=acceleration in the x direction in the reference coordinate system,

a^{R}_{y}=acceleration in the y direction in the reference coordinate system,

IVM=inverse vehicle model,

aₓ^{COG}, a_{y}^{COG}=acceleration in the motor vehicle coordinate system in the x and y direction,

a_{corr-x}^{COG}, a_{corr-y}^{COG}=correlated acceleration in the motor vehicle coordinate system in the x and y direction,

a_{wss}=acceleration calculation based on the rotational speed detected by the rotational speed sensor.

The area edged dashed can then be described as follows:

$$( \begin{matrix}{a}_{corr - x}^{COG} ( t ) \\ {a}_{corr - y}^{COG} ( t )\end{matrix} ) \approx ( \begin{matrix}cos a - sin aoffsetx \\ sin a - cos aoffsetx\end{matrix} ) \cdot ( \begin{matrix}{a}_{x}^{L} ( t ) \\ {a}_{y}^{L} ( t ) \\ 1\end{matrix} )$$

wherein offsetx represents the deviation in the x direction and offsety the deviation in the y direction. Furthermore, it applies that:

$$⇒ {a}_{corr - x}^{COG} ( t ) \approx ( {a}_{x}^{L} ( t ) - {a}_{y}^{L} ( t ) 1 ) \cdot ( \begin{matrix}cos a \\ sin a \\ offsetx\end{matrix} )$$

$$y ( t ) \approx {ϕ}^{T} ( t ) \cdot θ \\ ⇒ {a}_{corr - y}^{COG} ( t ) \approx ( {a}_{y}^{L} ( t ) - {a}_{x}^{L} ( t ) 1 ) \cdot ( \begin{matrix}cos a \\ sin a \\ offsety\end{matrix} )$$

$$y ( t ) \approx {ϕ}^{T} ( t ) \cdot θ$$

A number of measurement values produce, with the definition and consideration of corresponding error terms:

$$Y = ( \begin{matrix}y ( 1 ) \\ ⋮ \\ y ( n )\end{matrix} ) ; φ = ( \begin{matrix}{ϕ}^{T} ( 1 ) \\ ⋮ \\ {ϕ}^{T} ( n )\end{matrix} ) ; {ɛ}_{Corr - x} = ( \begin{matrix}{ɛ}_{Corr - x} ( 1 ) \\ ⋮ \\ {ɛ}_{Corr - x} ( n )\end{matrix} )$$

a system equation of the type:

Y=ϕ·θ+ε_{Corr-x}

θ here contains the wanted parameter α which represents the mounting angle of the inertial sensor 2. This type of calculation can be used as an off-line method in order to be able to estimate the mounting angle by means of existing measurements. For an implementation in running operation the calculation occurs recursively. In this context, the method described here makes use of the recursive least square method.

Step 1: Parameter update (P(t))

$$P ( t ) = P ( t - 1 ) - \frac{P ( t - 1 ) ϕ ( t ) {ϕ}^{T} ( t ) P ( t - 1 )}{1 + {ϕ}^{T} ( t ) P ( t - 1 ) ϕ ( t )}$$

Step 2: Calculation of the amplification

$$K ( t ) = \frac{P ( t - 1 ) ϕ ( t )}{1 + {ϕ}^{T} ( t ) P ( t - 1 ) ϕ ( t )} = P ( t ) ϕ ( t )$$

Step 3: Error calculation

ε(t)=y(t)−φ^{T}(t)\hat{θ}(t−1)

Step 4: Estimating the new parameter vector

\hat{θ}(t)=\hat{θ}(t−1)+K(t)ε(t)

The mounting angle is accordingly continuously reestimated. A following validation then provides information on whether the estimated angle can be trusted or whether the estimation method does not yet have adequate quality.

Using this method, it is possible that the inertial sensor 2 determines the real mounting position of the inertial sensor 2 in relation to the motor vehicle coordinate system in self-learning manner, particularly without additional hardware, if the rotational speed sensor 3 usually present in any case in the motor vehicle is accessed or manual input of parameters. By this means, a calibration of the inertial sensor 2 is possible in a simple manner. The inertial sensor 2 is, in particular, an inertial sensor permanently integrated in the vehicle, for example as a component of a safety system, particularly of an ESP braking system of the vehicle. Alternatively, according to a further exemplary embodiment, not shown here, the inertial sensor can also be the inertial sensor of a mobile computer which is arranged kept in the motor vehicle, wherein, when the method described before is carried out, the mounting position of the mobile computer in the motor vehicle is determined in a simple manner.

1. A method for operating an inertial sensor of a vehicle, the method comprising:
detecting, in operation of the vehicle, measurement data of at least one first measurement variable of the inertial sensor;
calibrating the inertial sensor by checking for error values in the measurement data of the at least one first measurement variable of the inertial sensor;
detecting, in operation of the vehicle, using a reference sensor, measurement data of a second measurement variable of the reference sensor that correlates with the at least one first measurement variable of the inertial sensor;
comparing the measurement data of the second measurement variable of the reference sensor with the measurement data of the at least one first measurement variable of the inertial sensor; and
detecting the error values based on a deviation of the measurement data of the at least one first measurement variable of the inertial sensor from the measurement data of the second measurement variable of the reference sensor.

2. The method as claimed in claim 1, wherein the reference sensor is a rotational speed sensor configured to detect the rotational speed of a wheel of the vehicle as the second measurement variable.

3. The method as claimed in claim 2, further comprising:
determining an acceleration of the vehicle based on the detected rotational speed.

4. The method as claimed in claim 3, the determining of the acceleration further comprising:
determining the acceleration based on a steering angle of the vehicle.

5. A method for operating a vehicle having at least one inertial sensor and a safety device configured to trigger in dependence on measurement data of at least one first measurement variable of the at least one inertial sensor, the method comprising:
detecting, in operation of the vehicle, the measurement data of the at least one first measurement variable of the at least one inertial sensor;
calibrating the at least one inertial sensor by checking for error values in the measurement data of the at least one first measurement variable of the at least one inertial sensor;
detecting, in operation of the vehicle, using a reference sensor, measurement data of a second measurement variable of the reference sensor that correlates with the at least one first measurement variable of the at least one inertial sensor;
comparing the measurement data of the second measurement variable of the reference sensor with the measurement data of the at least one first measurement variable of the at least one inertial sensor; and
detecting the error values based on a deviation of the measurement data of the at least one first measurement variable of the at least one inertial sensor from the measurement data of the second measurement variable of the reference sensor.

6. A vehicle comprising:
at least one inertial sensor configured to detect at least one first measurement variable;
at least one safety device configured to trigger in dependence on measurement data of the at least one first measurement variable of the at least one inertial sensor;
a reference sensor configured to detect a second measurement variable that correlates with the at least one first measurement variable of the at least one inertial sensor; and
a control device configured to:
detect, in operation of the vehicle, the measurement data of the at least one first measurement variable of the at least one inertial sensor;
calibrate the at least one inertial sensor by checking for error values in the measurement data of the at least one first measurement variable of the at least one inertial sensor;
detect, in operation of the vehicle, using the reference sensor, measurement data of the second measurement variable of the reference sensor;
compare the measurement data of the second measurement variable of the reference sensor with the measurement data of the at least one first measurement variable of the at least one inertial sensor; and
detect the error values based on a deviation of the measurement data of the at least one first measurement variable of the at least one inertial sensor from the measurement data of the second measurement variable of the reference sensor.

7. The vehicle as claimed in claim 6, wherein the at least one inertial sensor is permanently installed in the vehicle.

8. The vehicle as claimed in claim 6, wherein the at least one inertial sensor is a component of a mobile computer arranged in the vehicle.

9. The method as claimed in claim 1, wherein the vehicle is a motor vehicle.

10. The method as claimed in claim 5, wherein the vehicle is a motor vehicle.

11. The method as claimed in claim 5, wherein the safety device is an airbag.

12. The vehicle as claimed in claim 6, wherein the vehicle is a motor vehicle.
